(19) United States
(12) Patent Application Publication
(10) Pub. No.: US 2026/0338230 A1
(43) Pub. Date: Oct. 29, 2026

(54) ROLLING BEARING

(71) Applicant: NTN CORPORATION, OSAKA (JP)

(72) Inventors: Takeru ITO, Kuwana (JP); Hikaru ISHIDA, Kuwana (JP)

(73) Assignee: NTN CORPORATION, OSAKA (JP)

(21) Appl. No.: 19/647,503

(22) Filed: Apr. 14, 2026

Related U.S. Application Data
(63) Continuation of application No. PCT/JP2024/036284, filed on Oct. 10, 2024.

(30) Foreign Application Priority Data
Oct. 17, 2023 (JP) 2023-179036
Oct. 17, 2023 (JP) 2023-179083

(51) Int. Cl. F16C 33/38; F16C 33/66

(52) U.S. Cl. CPC F16C 33/3887; F16C 33/3812; F16C 33/6614; F16C 2206/40

(57) ABSTRACT

Provided is a rolling bearing including a retainer that can stabilize the behavior of the retainer and suppress wear. A retainer 6 of the rolling bearing has two annular bodies 10, 10 configured to be superposed on each other in an axial direction. Each of the annular bodies 10 includes: a plurality of pocket wall parts 13 arranged at predetermined intervals in a circumferential direction, each of which constitutes an inner wall surface of a pocket; and a plurality of connecting plate parts 14 connecting the pocket wall parts adjacent in the circumferential direction. The two annular bodies 10, 10 are superposed on and coupled to each other at the respective connecting plate parts 14. Both ends of each pocket 12 in the circumferential direction have contact parts P coming into contact with the balls at multiple points with intervals in a retainer axial direction C1.

### CROSS REFERENCE TO THE RELATED APPLICATION

This application is a continuation application, under 35 U.S.C. §111(a) of international patent application No. PCT/JP2024/036284, filed Oct. 10 2024, which claims priority to Japanese patent application No. 2023-179036, filed Oct. 17, 2023 and Japanese patent application No. 2023-179083, filed Oct. 17, 2023, the entire disclosures of all of which are herein incorporated by reference as a part of this application.

### BACKGROUND OF THE INVENTION

### Field of the Invention

The present invention relates to a rolling bearing such as a rolling bearing for a motor, as well as to a technology of stabilizing the behavior of a retainer and suppressing wear and excessive temperature rise.

### Description of Related Art

Patent Documents 1 and 2 disclose a synthetic resin retainer for a rolling bearing. The synthetic resin retainer includes two annular bodies having the same shape, which are configured to be engaged with each other.

In a rolling bearing in which lubrication is performed by grease, it has been known that grease adhering to surfaces of rotating balls is caught in a retainer pocket or a raceway surface, which affects parameters such as temperature rise of the bearing, vibration, and noise value. Thus, it can be considered that grease flow inside the bearing affects bearing performance. In recent years, the demand for a high-speed bearing is growing. In other words, a retainer which significantly affects grease flow is required to be adaptive to high-speed operation.

In the synthetic resin retainer of Patent Document 1, a notched part is provided on an inner or outer diametric surface of a pocket wall part to scrape off grease adhering to the balls. In the synthetic resin retainer of Patent Document 2, considering deformation of the retainer by centrifugal force, a relief shape in an axial direction of a pocket is formed as a cylindrical surface extending in a radial direction of the retainer on an inner diameter side from a pitch circle of the ball.

### Patent Document

[Patent Document 1] JP Laid-open Patent Publication No. 2020-159548

[Patent Document 2] JP Patent No. 5876237

### SUMMARY OF THE INVENTION

In Patent Document 1, the notched part is provided on the inner or outer diametric surface of the pocket wall part to improve performance of scrapping off grease adhering to the ball surfaces and shorten pre-conditioning time. In addition, a part of grease that tends to be retained in a static space is scraped off by the notched part, and therefore, base oil is supplied between the ball and the pocket, which makes it possible to suppress heat generation. Although the shape of the notched part is actually effective, there is a risk that centrifugal force acting on the retainer rotating at a high-speed deforms the pocket in a direction in which a gap between the ball and the pocket in an axial direction is reduced, and therefore, the ball interferes with the pocket in the axial direction. This may deteriorate parameters of the bearing such as abnormal wear and heat generation.

Patent Document 2 discloses a method to prevent interference between the pocket and the ball due to deformation of the retainer by centrifugal force. In Patent Document 2, to prevent interference between the pocket and the ball even when deformation occurs in an axial portion of the pocket of the retainer by centrifugal force, a relief shape in an axial direction of a pocket is formed as a cylindrical surface extending in a radial direction of the retainer on an inner diameter side from a pitch circle of the ball. Since interference between the pocket and the ball is prevented even when the pocket is deformed by centrifugal force, this shape can prevent abnormal wear. However, since the gap between the retainer and the ball in the axial direction becomes larger, vibration easily becomes larger.

Since the effects of centrifugal force is increased during high-speed rotation, the behavior of the retainer easily becomes unstable. In particular, the behavior of the retainer is unstable due to imbalance caused by variations in the weight balance of the retainer itself or the amount of grease adhering to the retainer. Moreover, as a conventional retainer 70 shown in FIG. 10, regarding the shape of the pocket, when the portion that comes into contact with the ball in a circumferential direction of rotation is a partial spherical surface 71 as sown in FIGS. 11 and 12, there are following problems. In Fig, 12, reference numeral A2 refers to a circumferential rotation progressing direction and reference numeral Ab refers to a range contactable with the ball.

As shown in FIG. 13A, when a ball 72 moves in the circumferential rotation progressing direction A2, a contact position in the circumferential direction between the retainer and the ball 72 is a single point as shown in FIG. 13B. Since a contact part P changes depending on the quality of the pocket of the retainer, the behavior of the retainer 70 is unstable. If rotation of the retainer 70 is unstable, an abnormal contact between the ball 72 and the retainer 70 is caused, which leads to the problems such as wear and excessive temperature rise. Reference numeral Pr in FIG. 13A refers to an R-shaped pocket of the retainer.

An object of the present invention is to provide a rolling bearing including a retainer that can stabilize the behavior of the retainer and suppress wear.

A rolling bearing of a first configuration of the present invention includes:
an inner ring;
an outer ring;
a plurality of balls interposed between the inner ring and the outer ring; and
a retainer having a pocket for retaining the balls; wherein
the retainer has two annular bodies configured to be superposed on each other in an axial direction; each of the annular bodies includes:
   a plurality of pocket wall parts arranged at predetermined intervals in a circumferential direction, each of which constitutes an inner wall surface of a pocket; and
   a plurality of connecting plate parts connecting the pocket wall parts adjacent in the circumferential direction;
   the two annular bodies are superposed on and coupled to each other at the respective connecting plate parts; and
   both ends of each pocket in the circumferential direction have contact parts coming into contact with the balls at multiple points with intervals in a retainer axial direction.

According to this configuration, the contact parts coming into contact with the ball at multiple points with intervals in the retainer axial direction are provided on both ends of each pocket in the circumferential direction. Since the retainer comes into contact with the ball at multiple points in the circumferential direction, force to move the retainer in the axial direction is not generated. Thus, as compared with the conventional retainer coming into contact with the balls at a single point in the circumferential rotation progressing direction, it is possible to stabilize the behavior in the retainer axial direction during high-speed rotation and reduce surface pressure of the contact part, which is advantageous for wear.

On both ends of each pocket in the circumferential direction, a plurality of tapered surfaces inclined with respect to a plane including a shaft center of the retainer and passing through a center of the pocket may be formed, and each contact part may be provided on each tapered surface. In this case, each tapered surface can easily be formed by a mold, which can reduce manufacturing costs.

The plurality of tapered surfaces formed on one end of each pocket in the circumferential direction may be provided on one of the annular bodies. In this case, since force in a direction in which the two annular bodies are separated is not generated, it is possible to prevent abnormalities in the retainer.

The ball may be a ceramic ball. In this case, for example, it is possible to increase rotation speed of the bearing by use of the balls having a lower specific gravity as compared with that of steel balls made of bearing steel or the like as well as to increase heat resistance.

The rolling bearing may be a rolling bearing for a motor. When the rolling bearing for a motor includes a retainer that can stabilize the behavior of the retainer and suppress wear, the rolling bearing can be applied to motors for various uses, which enhances versatility as the bearing for a motor.

Patent Document 2 discloses a method to prevent interference between the pocket and the ball due to deformation of the retainer by centrifugal force. In Patent Document 2, to prevent interference between the pocket and the ball even when deformation occurs in an axial portion of the pocket of the retainer by centrifugal force, a relief shape in an axial direction of the pocket is formed as a cylindrical surface extending in a radial direction of the retainer on an inner diameter side from a pitch circle of the ball. Since interference between the pocket and the ball is prevented even when the pocket is deformed by centrifugal force, this shape can prevent abnormal wear.

However, since the gap between the pocket and the ball becomes larger, the amount of grease entering the pocket increases at the start of the operation. This increases the pre-conditioning time, causes heat generation due to shear of grease and the ball in the pocket, and makes the behavior of the retainer unstable. One solution of the problem is to reduce the amount of grease filled. However, if the amount of grease filled is reduced, the problem about durability of the bearing occurs.

In the bearing closed by a seal, the space inside the bearing is roughly divided into a dynamic space, which is affected by the retainer and the ball due to rotation, and a static space, which is not affected by the retainer and the ball. Most of grease filled in the bearing moves to the static space during rotation. The ratio between the static space and the amount of grease filled (static space ratio) affects a bearing parameter. During high-speed rotation, a smaller static space ratio (i.e., the amount of grease filled is small) is advantageous to heat generation and vibration, since the amount of grease re-drawn is reduced when grease moves to the static space. However, as described above, when the static space ratio becomes smaller, the parameter for durability is lowered.

A rolling bearing of a second configuration of the present invention includes:
an inner ring;
an outer ring;
a plurality of balls interposed between the inner ring and the outer ring; and
a retainer having a pocket for retaining the balls; wherein
the retainer has two annular bodies configured to be superposed on each other in an axial direction;
each of the annular bodies includes:
   a plurality of pocket wall parts arranged at predetermined intervals in a circumferential direction, each of which constitutes an inner wall surface of a pocket; and
   a plurality of connecting plate parts connecting the pocket wall parts adjacent in the circumferential direction;
   the two annular bodies are superposed on and coupled to each other at the respective connecting plate parts and lubricated by grease; and
   a grease reservoir wall is provided on an inner circumferential surface of the connecting plate part to deposit grease and prevent grease from flowing axially outward from the inner circumferential surface.

According to this configuration, during rotation of the retainer, the grease reservoir wall deposits grease in the inner circumferential surface of the connecting plate part and prevents grease from flowing axially outward from the inner circumferential surface. This reduces the actual static space ratio to the amount of grease filled, which restrain excessive temperature rise of the bearing due to re-drawing grease moving from the dynamic space to the static space. In particular, since the amount of grease flowing during high-speed rotation is stabilized, temperature rise characteristic of the bearing can be stabilized.

Since the amount of grease adhering to an inner circumferential surface of the retainer can be controlled by the grease reservoir wall, an imbalance amount of retainer becomes smaller than that of the conventional structure. This stabilizes the behavior of the retainer. As compared with the conventional structure, it is possible to obtain effect of restraining temperature rise and stabilizing the behavior of the retainer without reducing the amount of grease filled, which is effective to durability of the bearing.

The grease reservoir walls may be provided on both edges in the axial direction of the inner circumferential surface of the connecting plate parts. In this case, the amount of grease held in the dynamic space can be increased as compared with the conventional structure. Therefore, the amount of grease moving to the static space can be reduced without changing the amount of grease filled, i.e., the static space ratio.

A minimum diameter of the grease reservoir wall may be larger than an outer diameter of the inner ring and smaller than an inner diameter of the retainer. In this case, when the two annular bodies are superposed on and coupled to each other at the respective connecting plate parts with respect to a sub-assembly of the inner ring, the outer ring and the balls, the assembly work can be easily performed without the grease reservoir wall interfering with the outer diameter of the inner ring.

The ball may be a ceramic ball. In this case, for example, it is possible to increase rotation speed of the bearing by use of the balls having a lower specific gravity as compared with that of steel balls made of bearing steel or the like as well as to increase heat resistance.

The rolling bearing may be a rolling bearing for a motor. When the rolling bearing for a motor has an effect of restraining excessive temperature rise, stabilizing the behavior of the retainer and not affecting durability, the rolling bearing can be applied to motors for various uses, which enhances versatility as the bearing for a motor.

The present invention encompasses any combination of at least two features disclosed in the claims and/or the specification and/or the drawings. In particular, any combination of two or more of the appended claims should be equally construed as included within the scope of the present invention.

### BRIEF DESCRIPTION OF THE DRAWINGS

The present invention will be more clearly understood from the following description of preferred embodiments made by referring to the accompanying drawings. However, the embodiments and the drawings are given merely for the purpose of illustration and explanation, and should not be used to delimit the scope of the present invention, which scope is to be delimited by the appended claims. In the accompanying drawings, alike symbols indicate alike or corresponding parts throughout the different figures.

FIG. 1 is a longitudinal sectional view of a rolling bearing according to a first embodiment of the present invention;

FIG. 2 is a front view of a retainer of the rolling bearing as viewed from an axial direction thereof;

FIG. 3A is a sectional view along IIIA-IIA line in FIG. 2;

FIG. 3B is a sectional view along IIIB-IIB line in FIG. 3A;

FIG. 4 is a sectional view along IV-IV line in FIG. 2;

FIG. 5A is a partially enlarged view showing a relevant part of the retainer;

FIG. 5B is a partially enlarged view showing contact parts between the retainer and a ball;

FIG. 6 illustrates result of radial vibration for the rolling bearing and a comparison example including a conventional retainer;

FIG. 7 illustrates results of axial vibration for the rolling bearing and the comparison example including the conventional retainer;

FIG. 8 is a conceptual view of a bearing for a motor in which the rolling bearing is applied to the motor;

FIG. 9A is a partially enlarged view of a retainer of a rolling bearing according to a second embodiment of the present invention;

FIG. 9B is a partially enlarged view of a retainer of a rolling bearing according to a third embodiment of the present invention;

FIG. 9C is a partially enlarged sectional view of a retainer of a rolling bearing according to a fourth embodiment of the present invention;

FIG. 10 is a front view of the conventional retainer as viewed from an axial direction thereof;

FIG. 11 is a sectional view along XI-XI line in FIG. 10;

FIG. 12 is a sectional view along XII-XII line in FIG. 10;

FIG. 13A is a partially enlarged view showing a relevant part of the conventional retainer;

FIG. 13B is a partially enlarged view showing a contact part between the conventional retainer and a ball;

FIG. 14 is a longitudinal sectional view of a retainer of a rolling bearing according to a fifth embodiment of the present invention;

FIG. 15 is a perspective view of a retainer of the rolling bearing;

FIG. 16 is a front view of the retainer as viewed from an axial direction thereof;

FIG. 17 A is an enlarged sectional view of the retainer;

FIG. 17 B is a sectional view along XVIIB-XVIIB line in FIG. 17A;

FIG. 18 A is a sectional view along XVIIIA-XVIIIA line in FIG. 16;

FIG. 18B illustrates a state where the amount of grease is controlled in FIG. 18A;

FIG. 19 is an enlarged perspective view showing a relevant part of the retainer;

FIG. 20 is an enlarged sectional view of a central part of the retainer in the axial direction;

FIG. 21 shows results of a temperature rise test of the retainer and the conventional retainer; and

FIG. 22 is a conceptual view of a bearing for a motor in which the rolling bearing is applied to the motor.

### DESCRIPTION OF THE EMBODIMENTS

### First Embodiment

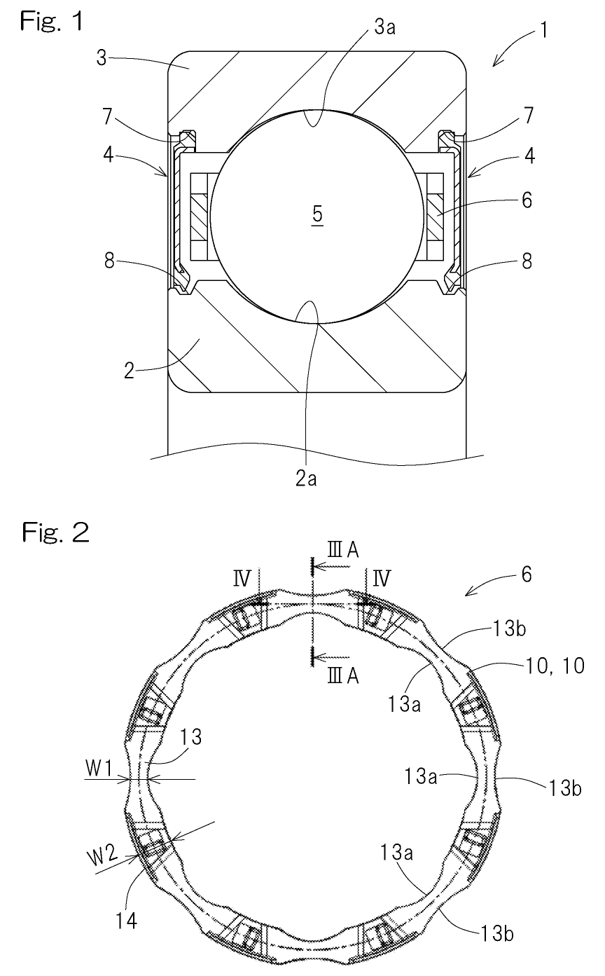

A rolling bearing according to an embodiment of the present invention will be described with reference to FIGS. 1 - 7.

### Rolling Bearing

As shown in FIG. 1, a rolling bearing 1 of this example is a deep groove ball bearing lubricated by grease including: an inner ring 2; an outer ring 3; a plurality of balls 5 as rolling elements interposed between rolling surfaces 2a, 3a of the inner and outer rings 2, 3; a retainer 6 for retaining the respective balls 5; and a seal 4. The balls 5 are steel balls or ceramic balls.

In this specification, an “axial direction” is referred to as a direction along a bearing central line of the rolling bearing 1, and a “radial direction” is referred to as a direction orthogonal to a straight line forming the “axial direction”.

An annular space is defined between an outer periphery of the inner ring 2 and an inner periphery of the outer ring 3, and openings at opposite axial ends of the annular space are closed by the seals 4, 4. The closed annular space is filled with grease for lubrication. The outer ring 3 has an inner peripheral surface formed with seal fitting grooves 7, and the inner ring 2 has an outer peripheral surface formed with inner-ring sealing grooves 8. Each seal 4 of this example is a non-contact seal in which the inner-ring sealing groove 8 does not come into contact with a lip. The seal 4 is made by molding a rubber member on a core metal, and an outer peripheral edge of the seal 4 is fitted into and fixed to the seal fitting groove 7 of the outer ring 3.

### Retainer

The retainer 6 of FIG. 2 is a rolling element guided type retainer that is constituted by two annular bodies 10, 10 configured to be made of a synthetic resin and superposed on each other in an axial direction. In the retainer 6 in which the two annular bodies 10, 10 are coupled to each other, as shown in FIG. 2, each outer diameter surface of the annular bodies 10, 10 is provided to have the same diameter except for a notched part 13b, and each inner diameter surface of the annular bodies 10, 10 is provided to have the same diameter except for a notched part 13a. Each annular body 10 is formed by, for example, injection molding of the synthetic resin. The two annular bodies 10, 10 have the same shape and can be molded from the same mold.

The synthetic resin may be any material that can be formed by injection molding and has sufficient heat resistance, oil resistance and mechanical strength as material used for a retainer such as polyolefin resin, thermosetting resin, engineering plastic, or super-engineering plastic. Considering heat resistance, the retainer 6 should be made of resin material having a melting point of 200°C-360°C, preferably 200°C-350°C. When the melting point is less than 200°C, there is a risk that the resin melts or wears abnormally due to frictional heat generated by the sliding between the ball and a pocket wall part. To enhance strength, a resin to which 15-45 mass% of glass fiber, carbon fiber or aramid fiber is added can be used, but a resin without these fibers can also be used.

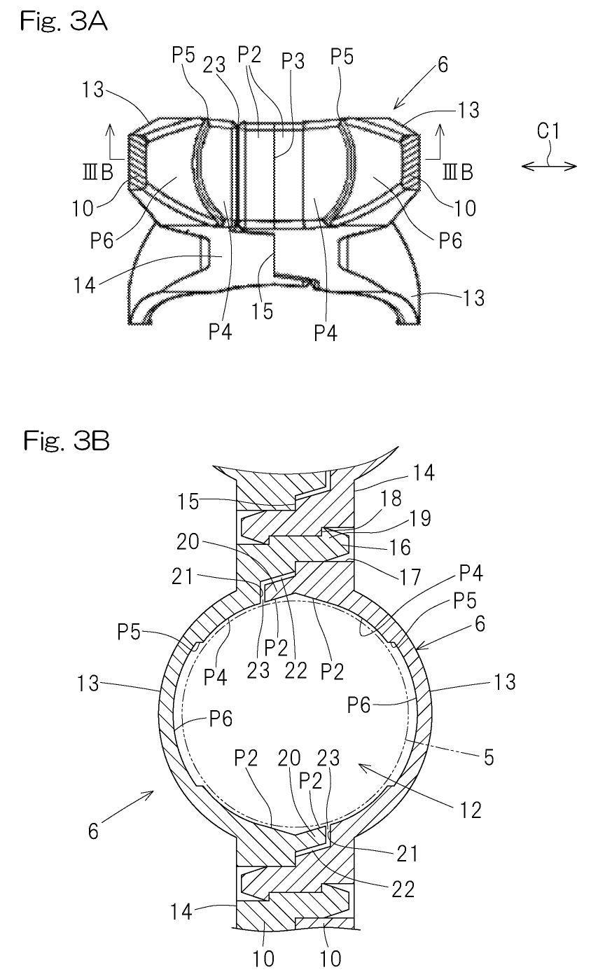

As shown in FIG. 3A and FIG. 3B, each annular body 10 includes a plurality of semicylindrical pocket wall parts 13 and a plurality of connecting plate parts 14. The plurality of semicylindrical pocket wall parts 13 are arranged at predetermined intervals in a circumferential direction, and each of the pocket wall parts constitutes an inner wall surface of a pocket 12 for retaining the ball 5. The plurality of connecting plate parts 14 connect the pocket wall parts 13 adjacent in the circumferential direction.

As shown in FIG. 3B, each connecting plate part 14 has an abutting surface 15 which comes into surface contact with another abutting surface of a corresponding connecting plate part when the two annular bodies 10, 10 are coupled to each other. Each connecting plate part 14 has, in the vicinity of the center of the abutting surface 15 thereof in the circumferential direction, a coupling claw 16 projecting in the axial direction and a coupling hole 17 into which a corresponding coupling claw 16 of the other annular body 10 is inserted.

The coupling claw 16 has an axial tip end portion formed with a hook portion 19, and the hook portion 19 of one annular body 10 engages with a stepped portion 18 formed on an inner surface of a corresponding coupling hole 17 of the other annular body 10. Thanks to this engagement, the coupling claw 16 is locked in the coupling hole 17, and the two annular bodies 10, 10 are coupled to each other.

Each connecting plate part 14 includes a projecting wall part 20 and a receiving recess 21. The projecting wall part 20 is formed at one circumferential end of each abutting surface 15 of one annular body 10 so as to protrude in the axial direction. The receiving recess 21 is formed at the other circumferential end of each abutting surface 15 of one annular body 10 and receives a corresponding projecting wall part 20 of the other annular body 10. Since the respective connecting plate parts 14 have the projecting wall parts 20 and the receiving recesses 21 as described above, when the two annular bodies 10, 10 are coupled to each other, the abutment line of the annular bodies 10, 10 is located at a position displaced from the axial center of the pockets 12. When the two annular bodies 10, 10 are coupled to each other, the pocket 12 is a space formed by portions of the pocket wall parts 13, 13 facing each other in the axial direction and portions of the connecting plate parts 14, 14 which are connected to the pocket wall parts 13, 13 and face each other in the circumferential.

The projecting wall parts 20 and the receiving recesses 21 are dimensioned such that circumferential and axial gaps 22, 23 are defined between the projecting wall parts 20 and the receiving recesses 21 when the two annular bodies 10, 10 are coupled to each other. This makes it possible to prevent interference between the projecting wall parts 20 and the receiving recesses 21 due to contraction difference after injection molding of the annular bodies 10 and to ensure that the abutting surfaces 15 of the connecting plate parts 14 of the two annular bodies 10, 10 are closely fitted to each other.

### Contact Part

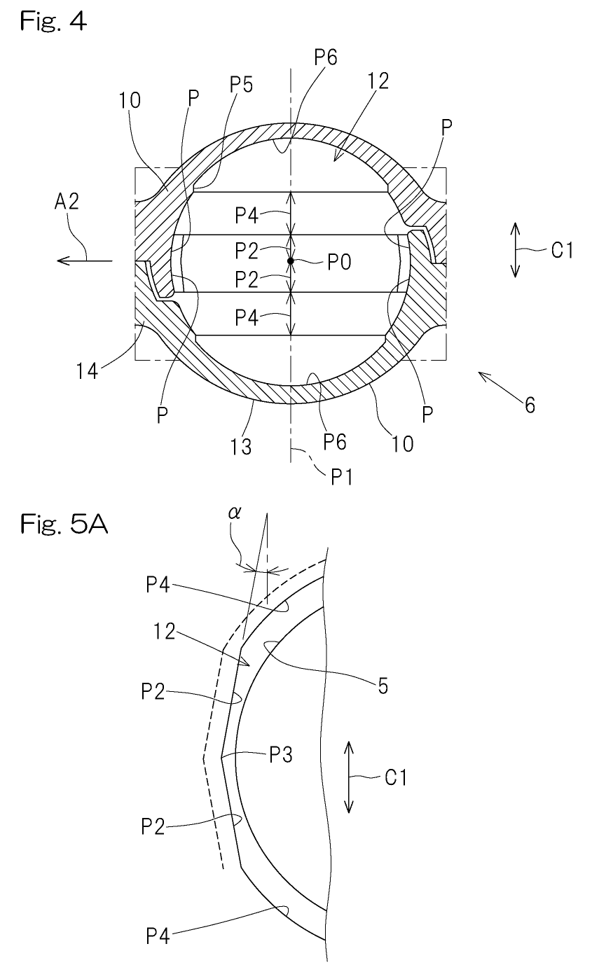

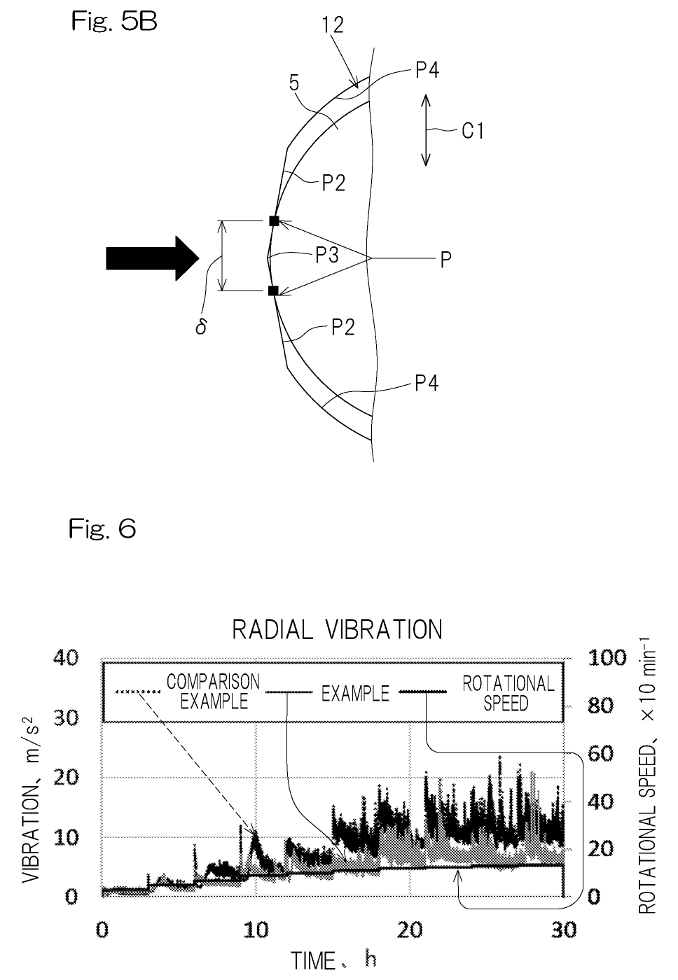

As shown in FIG. 4, the contact parts P coming into contact with an outer periphery of the ball 5 (FIG. 5A) at multiple points (two points in this example) with a predetermined interval δ (FIG. 5B) in a retainer axial direction C1 are provided on both ends of each pocket 12 in the circumferential direction. The “retainer axial direction” C1 is referred to as a direction along a shaft center of the retainer as a rotational axis of the retainer 6. The reference numeral A2 in FIG. 4 indicates a circumferential rotation progressing direction of the retainer. The interval δ of the two contact parts P shown in FIG. 5B is appropriately predetermined in accordance with, for example, the bearing size or results of a vibration test described below.

On both ends of each pocket 12 in the circumferential direction shown in FIG. 4, a plurality of tapered surfaces P2 (two tapered surfaces in this example) inclined at a predetermined angle α with respect to a plane P1 including the shaft center of the retainer and passing through a center P0 of the pocket is formed as shown in FIG. 5A. As shown in FIG. 5B, each contact part P is provided on each tapered surface P2. On one end of each pocket 12 in the circumferential direction, a tapered edge P3, where the tapered surfaces P2, P2 adjacent to each other are connected, is located at an axial intermediate part of the pocket 12. A tapered edge P3 on the other end of each pocket 12 is also located at an axial intermediate part of the pocket 12.

As shown in FIG. 3A, the tapered surfaces P2, P2, partial spherical surfaces P4, P4 and substantially cylindrical surfaces P6, P6 via flat surfaces P5, P5 as steps are sequentially connected from the tapered edge P3 of each pocket 12 as a reference point to both sides in the retainer axial direction. The partial spherical surface P4 has a partial spherical surface form whose spherical surface R that is slightly larger than the diameter of the ball 5. A spherical surface center of the partial spherical surface P4 is the center P0 of the pocket (FIG. 4). As shown in FIG. 4, the two tapered surfaces P2, P2 formed on one end of each pocket 12 in the circumferential direction are provided on one of the annular bodies 10. The two tapered surfaces P2, P2 formed on the other end of each pocket 12 in the circumferential direction are provided on one of the annular bodies 10 coupled to the annular body 10.

### Notched Part

As shown in FIG. 2, in the retainer 6, notched parts 13a, 13b are provided on an inner diametric surface and an outer diametric surface of the pocket wall part 13 so that a width W1, which is a radial dimension of one pocket wall part 13, is smaller than a radial dimension W2 of one connecting plate part 14. Each of the notched parts 13a, 13b on the inner and outer diametric surfaces is shaped as a curved surface which defines a concave curve when viewed from the axial direction of the bearing. The notched parts 13a, 13b may be formed, for example, during injection molding of the annular body 10, or may be formed by mechanical processing after injection molding.

In each pocket wall part 13, a deepest portion of the notched part 13a on the inner diametric surface is provided on a circumferential intermediate part of the inner diametric surface, and a deepest portion of the notched part 13b on the outer diametric surface is provide on a circumferential intermediate part of the outer diametric surface. In each pocket wall part 13, the width W1 is smallest at the circumferentially intermediate part and gradually increases along the curved surface shape from the circumferentially intermediate part toward the opposite circumferential ends of the pocket wall part.

### Vibration Test

A vibration test was carried out on a deep groove ball bearing including a retainer according to this embodiment (Example) and a deep groove ball bearing including a conventional retainer that comes into contact with a ball at a single point (Comparison Example).

Test Conditions:

Tester: high-speed tester

Test bearing: deep groove ball bearing, model number 6312 (inner diameter of inner ring φ = 60mm, outer diameter of outer ring φ = 130mm, width = 31 mm), sealed on both sides, lubricated by grease

Rotational speed: stepped up from 3000 min⁻¹ to 13500min⁻¹

Load: axial load Fa = 588.4 N

Measurement item: vibration acting on the outer ring of the bearing in the radial direction (radial vibration), vibration acting on the outer ring of the bearing in the axial direction (axial vibration)

The high-speed tester was of inner-ring rotation type driven by a motor, in which the two deep groove ball bearings were arranged in a housing at predetermined intervals in the axial direction. In the housing, vibration sensors that can measure vibration of the outer ring of each deep groove ball bearing in the radial direction and the axial direction were provided. As the vibration sensor, for example, a piezoelectric element type, electromagnetic type, or capacitance type vibration sensor was used. Vibration values of the deep groove ball bearing closer to the motor under more severe vibration condition were adopted from those of the two deep groove ball bearings arranged at predetermined intervals in the axial direction.

### Results of Vibration Test

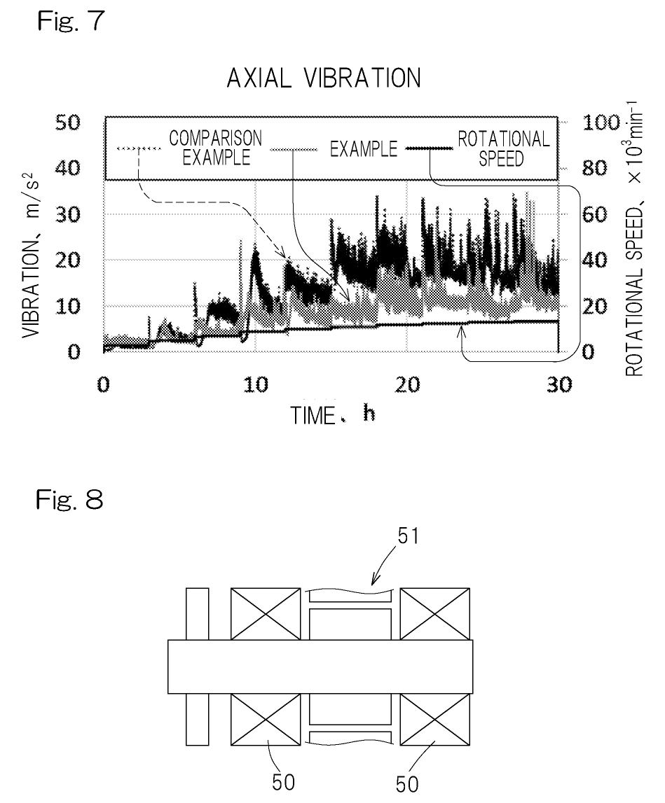

As shown in FIGS. 6 and 7, in Example as compared with Comparison Example, both radial vibration and axial vibration were suppressed over the whole range of rotational speed, and the behavior of the retainer was stabilized.

### Effects and Advantages

According to the above-described rolling bearing 1 in FIG. 1, as shown in FIG. 4, the contact parts P coming into contact with the ball at multiple points with a predetermined interval in the retainer axial direction C1 are provided on both ends of each pocket 12 in the circumferential direction. Since the retainer 6 comes into contact with the ball at two points in the circumferential direction, force to move the retainer 6 in the axial direction is not generated. Thus, as compared with the conventional retainer coming into contact with the ball at a single point in the circumferential rotation progressing direction, the retainer 6 makes it possible to stabilize the behavior in the retainer axial direction C1 during high-speed rotation and reduce surface pressure of the contact part P, which is advantageous for wear.

On both ends of each pocket 12 in the circumferential direction, the plurality of tapered surfaces P2 inclined with respect to the plane P1 including the shaft center of the retainer and passing through the center P0 of the pocket is formed, and each contact part P is provided on each tapered surface P2. In this case, each tapered surface P2 can easily be formed by a mold, which can reduce manufacturing costs.

The two tapered surfaces P2, P2 formed on one end of each pocket 12 in the circumferential direction are provided on one of the annular bodies 10. In this case, force in a direction in which the two annular bodies 10, 10 are separated is not generated, and stress is generated on one annular body 10 of the two annular bodies 10, 10. Thus, since excessive load is not applied to the coupling claw 16 in FIG. 3B, it is possible to prevent abnormalities in the coupling claw 16. Consequently, it is possible to prevent abnormalities in the retainer.6.

### Rolling Bearing for Motor

The rolling motor is used, for example, as rolling bearings 50, 50 for a motor 51 as schematically shown in FIG. 8. However, the rolling bearing can be applied to various uses other than motors.

When the rolling bearing is the rolling bearing for a motor and the rolling bearing for a motor includes a retainer that can stabilize the behavior of the retainer and suppress wear, the rolling bearing can be applied to motors for various uses, which enhances versatility as the bearing for a motor.

### Other Embodiments

In the following description, the same reference numerals are used to denote parts that correspond to those previously described in the respective embodiments, and overlapping description is omitted. Where only a part of a configuration is described, the rest of the configuration is to be construed as being the same as the previously described embodiments unless otherwise indicated. The same configurations provide the same effects. It is possible not only to combine the parts that have been particularly described in the respective embodiments but also to partly combine the embodiments unless there is any hindrance to such a combination.

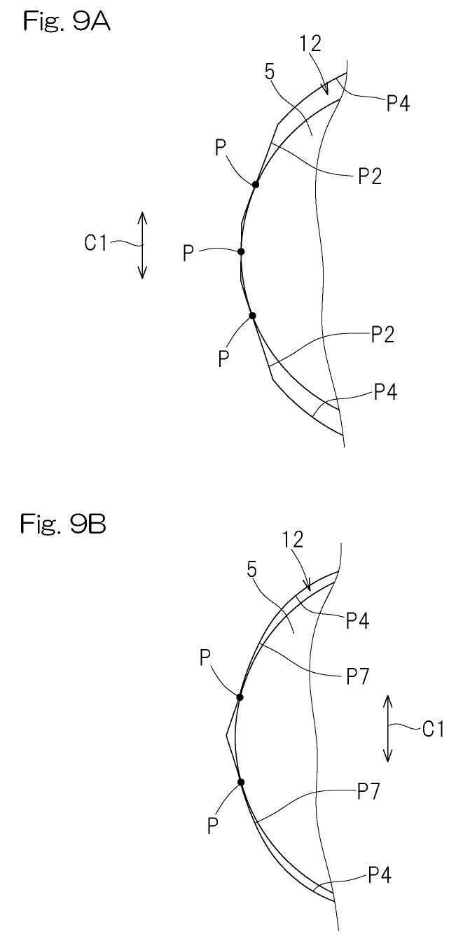

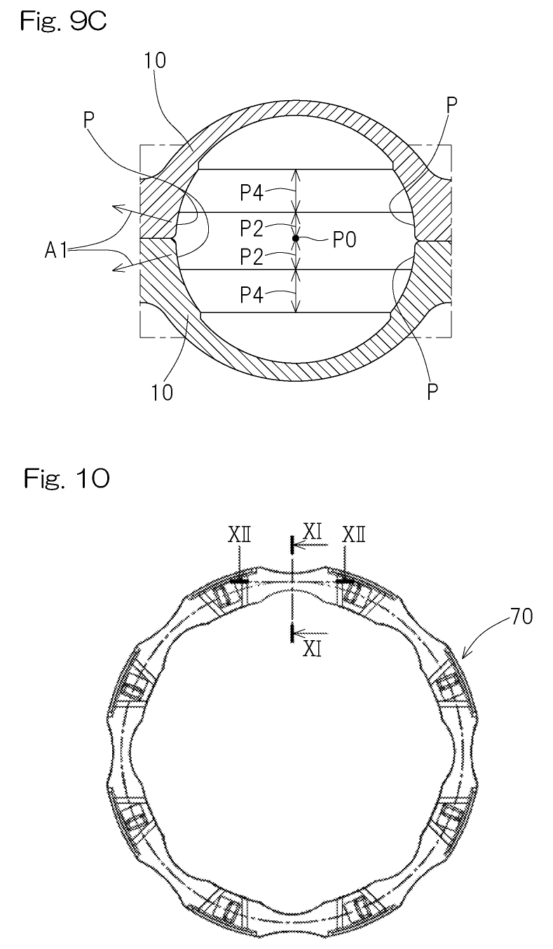

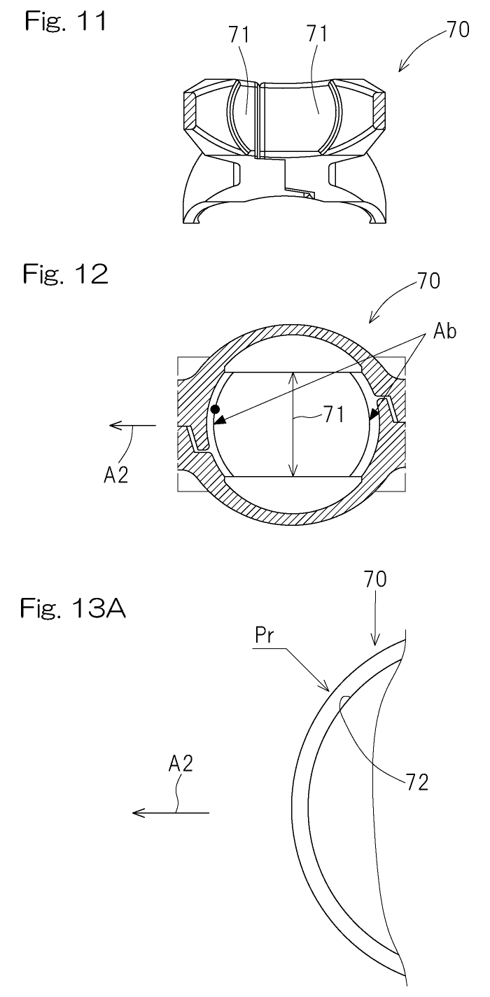

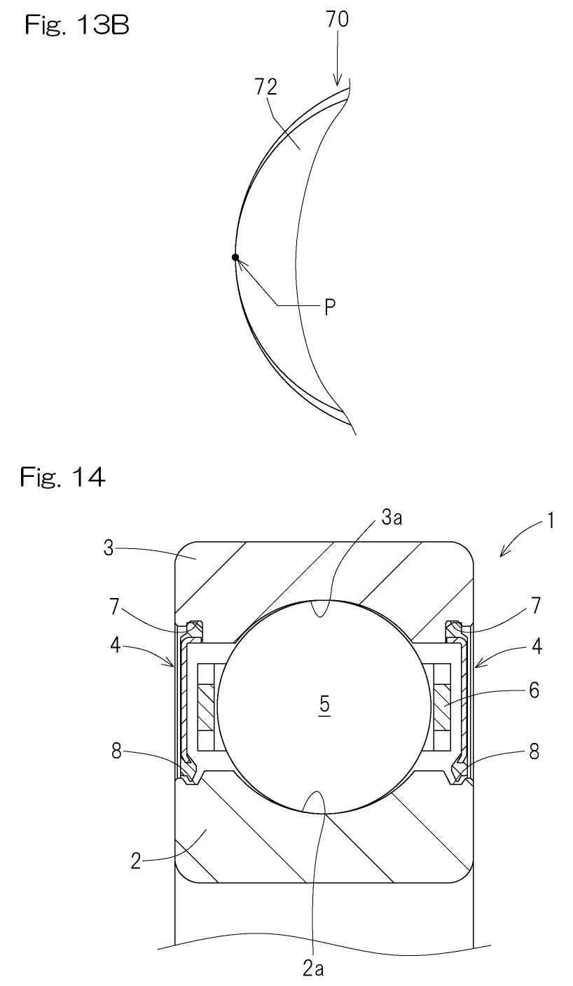

### Second Embodiment: FIG. 9A, Three Contact Points

As shown in FIG. 9A, the contact parts P coming into contact with the ball at three points may be provided on both ends of each pocket 12 in the circumferential direction. In this case, as compared with the conventional retainer coming into contact with the ball at a single point in the circumferential rotation progressing direction, it is possible to further reduce surface pressure of the contact part P, which is advantageous for wear.

### Third Embodiment: FIG. 9B, Compound Curved Surface

On both ends of each pocket 12 in the circumferential direction, instead of each tapered surface P2 in FIG. 5B, curved concave surfaces P7 may be provided, and the contact parts P may be provided on each curved concave surface P7. Each curved concave surface, for example, consists of a cylindrical surface extending along the radial direction of each pocket 12. According to this configuration, almost the same effects and advantages as those described for the first embodiment are provided.

### Fourth Embodiment; FIG. 9C, Tapered Surfaces Provided on Each Annular Body

For example, when used at medium to low rotation speeds, as shown in FIG. 9C, the tapered surfaces P2 may be provided on each annular body 10, and the contact parts may be provided on each tapered surface P2. However, during high-speed rotation, since force in a direction A1 in which the two annular bodies 10 are separated is generated, this embodiment is not suitable for use.

In the pocket wall part 13 in FIG. 4, the cylindrical surfaces P6, P6 on both sides in the retainer axial direction may be partial spherical surfaces.

### Fifth Embodiment

The rolling bearing according to this embodiment of the present invention is shown in FIGS. 14-21.

As shown in FIG. 14, the rolling bearing 1 according to the fifth embodiment has a schematic configuration similar to that of the rolling bearing according to the first embodiment above. In the fifth embodiment, the same reference numerals are used to denote configurations that correspond to those of the first embodiment, and detailed description is omitted.

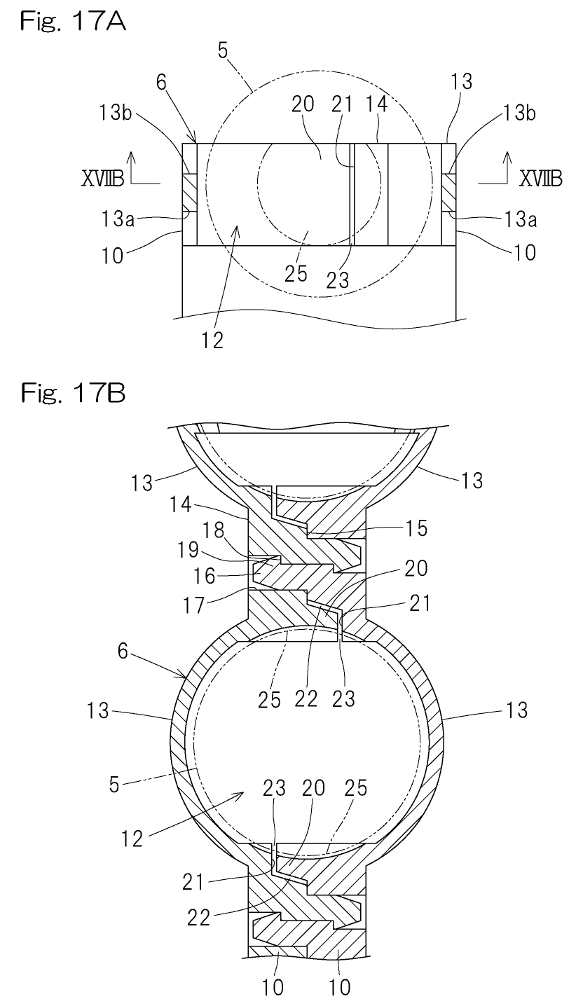

As shown in FIG. 17B, each connecting plate part 14 includes a projecting wall part 20 and a receiving recess 21. The projecting wall part 20 is formed at one circumferential end of each abutting surface 15 of one annular body 10 so as to protrude in the axial direction. The receiving recess 21 is formed at the other circumferential end of each abutting surface 15 of one annular body 10 and receives a corresponding projecting wall part 20 of the other annular body 10. Since the respective connecting plate parts 14 have the projecting wall parts 20 and the receiving recesses 21 as described above, when the two annular bodies 10, 10 are coupled to each other, the abutment line of the annular bodies 10, 10 is located at a position displaced from the axial center of the pockets 12. This makes it possible to prevent the ball 5 from coming into contact with the abutment line of the two annular bodies 10, 10 when the ball 5 comes into contact with the connecting plate part 14 due to delay or advance of the ball 5 during bearing operation. Therefore, it is possible to retain the ball 5 stably. When the two annular bodies 10, 10 are coupled to each other, the pocket 12 is a space formed by portions of the pocket wall parts 13, 13 facing each other in the axial direction and portions of the connecting plate parts 14, 14 which are connected to the pocket wall parts 13, 13 and face each other.

Each pocket 12 has opposite circumferential end portions each formed with a partial concave spherical surface 25 matching the outer periphery of a corresponding ball 5. The partial concave spherical surfaces 25 at the opposite circumferential end portions are formed so as to face each other at front and rear positions with respect to the direction of movement of the ball 5 interposed therebetween. The partial concave spherical surface 25 has a slightly larger radius of curvature than the radius of the ball 5.

### Grease Reservoir Wall

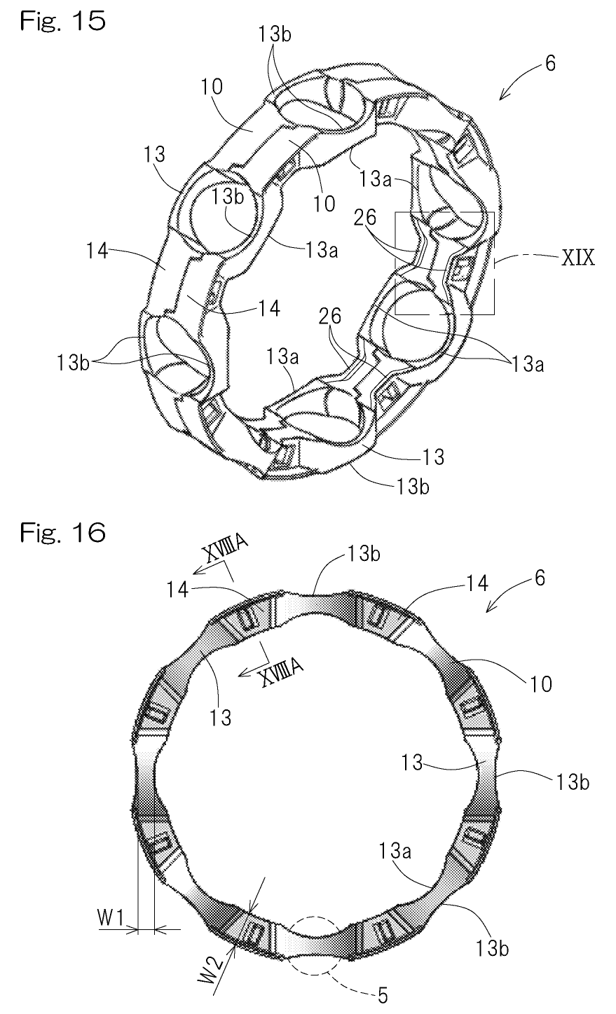

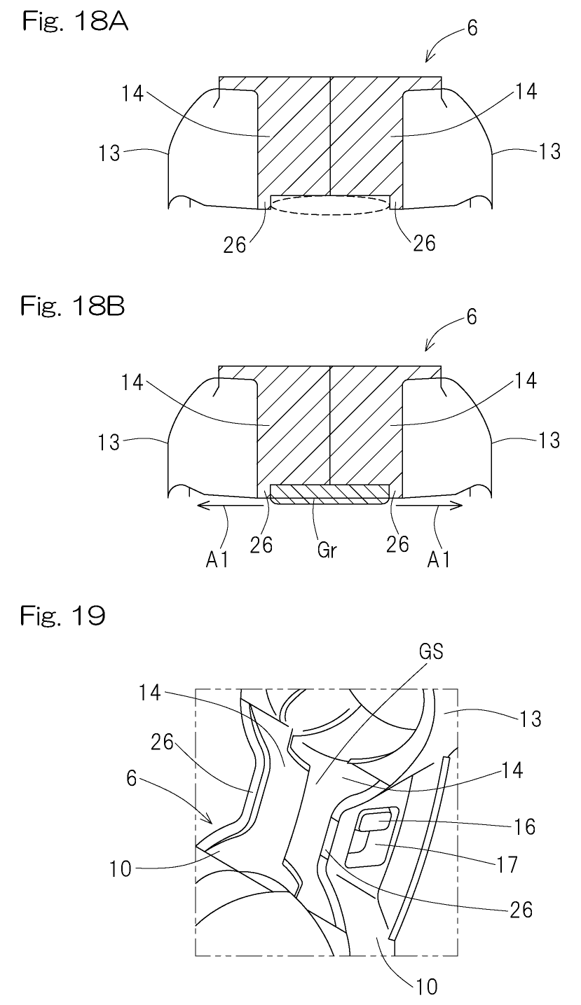

As shown in FIG. 18A, grease reservoir walls 26, 26 are provided on the inner circumferential surfaces of the connecting plate parts 14, 14. As shown in FIG. 19 that is an enlarged perspective view of XIX part of FIG. 15, the grease reservoir walls 26, 26 are integrally formed on both edges in the axial direction of the inner circumferential surfaces of the connecting plate parts 14, 14. As shown in FIG. 18B, the grease reservoir walls 26, 26 deposit grease Gr in the inner circumferential surfaces of the connecting plate parts 14, 14 and prevent the grease Gr from flowing to an axially outer side A1 from the inner circumferential surfaces. By adjusting height of the grease reservoir wall 26, i.e., height in the radial direction, it is possible to control the amount of grease adhering to the inner circumferential surfaces of the connecting plate parts 14, 14. In other words, when the grease Gr deposited exceeds the height of the grease reservoir wall 26, the grease Gr exceeding the height of the grease reservoir wall 26 flows. On the other hand, a certain amount of the grease Gr stored in a grease storing space GS (FIG. 19) within the height of the grease reservoir wall 26 remains adhered to the inner circumferential surfaces of the connecting plate parts 14, 14.

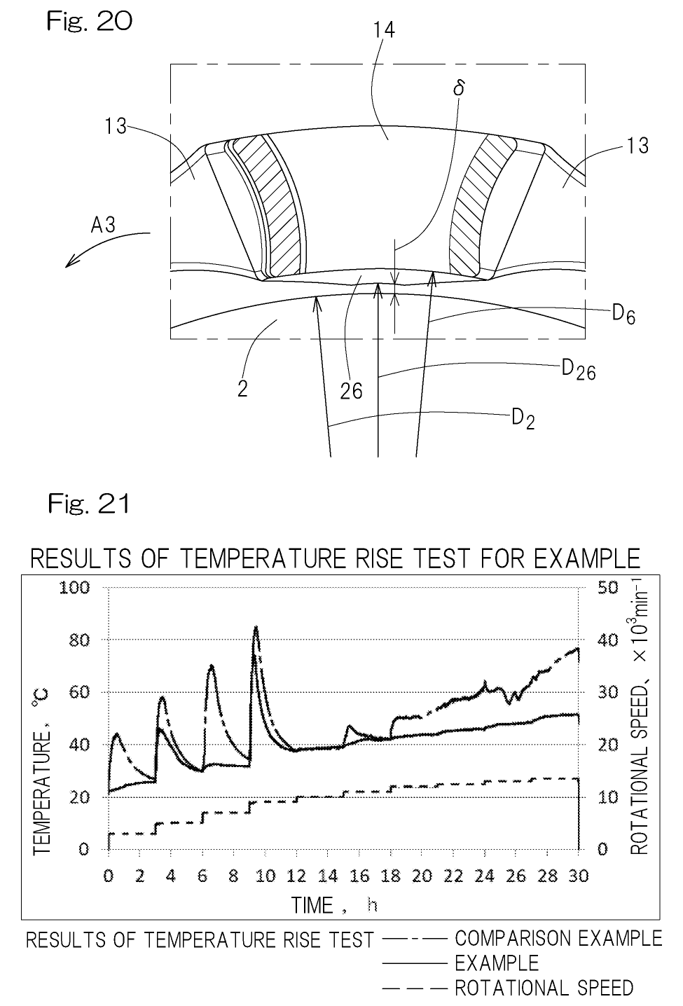

As shown in FIG. 20, a minimum diameter D₂₆ of the grease reservoir 26 is larger than an outer diameter D₂ of the inner ring and smaller than an inner diameter D₆ of the retainer, i.e., (the inner diameter D₆ of the retainer) > (the minimum diameter D₂₆of the grease reservoir wall 26) > (the outer diameter D₂ of the inner ring). A predetermined gap δ in the radial direction is provided between the minimum diameter D₂₆ of the grease reservoir wall 26 and the outer diameter D₂ of the inner ring. The grease reservoir wall 26 has a maximum height at the circumferentially intermediate part of the inner circumferential surface of the connecting plate part 14. The circumferentially intermediate part at which the grease reservoir wall 26 has the maximum height is the minimum diameter D₂₆ of the grease reservoir wall 26. The height of the grease reservoir wall 26 is formed to gradually decrease from the circumferentially intermediate part toward the opposite circumferential ends. In FIG. 20, reference numeral A3 refers to a rotational direction of the retainer.

### Temperature Rise Test

A temperature rise test was carried out with and without the grease reservoir wall 26.

Test Conditions:

Tester: high-speed tester

Test bearing: deep groove ball bearing, model number 6312 (inner diameter of inner ring φ = 60mm, outer diameter of outer ring φ = 130mm, width = 31 mm), sealed on both sides, lubricated by grease

Rotational speed: stepped up from 3000 min⁻¹ to 13500min⁻¹

Load: axial load Fa = 588.4 N

Measurement item: temperature of the outer ring of the bearing

The high-speed tester was of inner-ring rotation type driven by a motor, in which the two deep groove ball bearings were arranged in a housing at predetermined intervals in the axial direction. In the housing, thermocouples for measuring temperature of the outer ring of each deep groove ball bearing were provided. In the deep groove ball bearing including the conventional retainer without the grease reservoir wall (Comparison Example) and the deep groove ball bearing including the retainer with the grease reservoir wall (Example), temperature of the deep groove ball bearing closer to the motor under more severe temperature condition were adopted from those of the two deep groove ball bearings.

### Results of Temperature Rise Test

As shown in FIG. 21, in Example with the grease reservoir wall as compared with Comparison Example without the grease reservoir wall, it was possible to suppress a rapid temperature rise and achieve high-speed operation.

### Effects and Advantages

According to the bearing 1 in FIG. 14 described above, during rotation of the retainer in FIG. 19, the grease reservoir walls 26, 26 deposit grease in the inner circumferential surfaces of the connecting plate parts 14, 14 and prevent grease from flowing axially outward from the inner circumferential surfaces. This reduces the actual static space ratio to the amount of grease filled, which restrain excessive temperature rise of the bearing due to re-drawing grease moving from the dynamic space to the static space. In particular, since the amount of grease flowing during high-speed rotation is stabilized, temperature rise characteristic of the bearing can be stabilized. The term “static space” as used herein means a bearing space between the inner ring and the outer ring, where the balls and the retainer do not pass through while the bearing rotates.

Since the amount of grease adhering to an inner circumferential surface of the retainer 6 can be controlled by the grease reservoir walls 26, 26, an imbalance amount of the retainer 6 becomes smaller than that of the conventional structure. This stabilizes the behavior of the retainer 6. As compared with the conventional structure, it is possible to obtain effect of restraining temperature rise and stabilizing the behavior of the retainer 6 without reducing the amount of grease filled, which is effective to durability of the bearing.

The grease reservoir walls 26, 26 are provided on both edges in the axial direction of the inner circumferential surface of the connecting plate parts 14, 14. In this case, the amount of grease held in the dynamic space can be increased as compared with the conventional structure. Therefore, the amount of grease moving to the static space can be reduced without changing the amount of grease filled, i.e., the static space ratio.

As shown in FIG. 20, the minimum diameter D₂₆ of the grease reservoir wall 26 is larger than the outer diameter D₂ of the inner ring and smaller than the inner diameter D₆of the retainer. In this case, when the two annular bodies 10, 10 in FIG. 15 are superposed on and coupled to each other at the respective connecting plate parts 14, 14 with respect to a sub-assembly of the inner ring 2, the outer ring 3 and the balls 5 of FIG. 14, the assembly work can be easily performed without the grease reservoir walls 26, 26 interfering with the outer diameter of the inner ring.

### Rolling Bearing for Motor

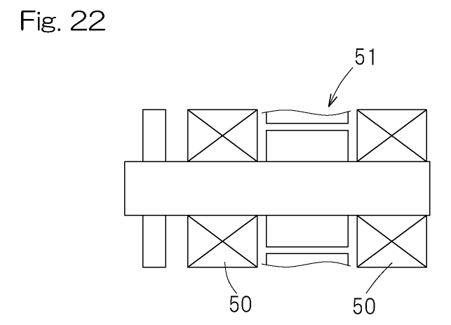

The rolling motor is used, for example, as rolling bearings 50, 50 for a motor 51 as schematically shown in FIG. 22. However, the rolling bearing can be applied to various uses other than motors.

When the rolling bearing is the rolling bearing for a motor and the rolling bearing for a motor has an effect of restraining excessive temperature rise, stabilizing the behavior of the retainer and not affecting durability, the rolling bearing can be applied to motors for various uses, which enhances versatility as the bearing for a motor.

### Other Embodiments

The grease reservoir walls 26, 26 may be provided in addition to both edges in the axial direction of the inner circumferential surfaces of the connecting plate parts 14, 14 shown in FIG. 18A. For example, a pair of grease reservoir walls may be provided on the intermediate part of the inner circumferential surface in the axial direction.

The pocket wall parts 13 of each annular body 10 in FIG. 15 are not limited to being semicylindrical, but may be hemispherical.

The seal 4 in FIGS. 1 and 14 may be a contact seal in which the inner-ring sealing groove 8 comes into contact with a lip.

The seal 4 may be a so-called shield plate made only of steel plate.

The rolling bearing may be a rolling bearing of open type which do not include the seal 4.

Any of the rolling bearing may be applied to a machine tool, an industrial machine and a vehicle.

Each annular body can also be produced by a 3D printer or machining.

Although the present invention has been described in terms of the preferred embodiments thereof with reference to the drawings, various additions, modifications, or deletions may be made without departing from the scope of the invention. Accordingly, such variants are included within the scope of the present invention.

### REFERENCE NUMERALS

1 Rolling bearing

2 Inner ring

3 Outer ring

5 Ball

6 Retainer

10 Annular body

12 Pocket

13 Pocket wall part

14 Connecting plate part

P Contact part

P2 Tapered surface

What is claimed is:

1. A rolling bearing comprising:
an inner ring;
an outer ring;
a plurality of balls interposed between the inner ring and the outer ring; and
a retainer having a pocket for retaining the balls; wherein
the retainer has two annular bodies configured to be superposed on each other in an axial direction;
each of the annular bodies includes: a plurality of pocket wall parts arranged at predetermined intervals in a circumferential direction, each of which constitutes an inner wall surface of a pocket; and a plurality of connecting plate parts connecting the pocket wall parts adjacent in the circumferential direction;
the two annular bodies are superposed on and coupled to each other at the respective connecting plate parts; and
both ends of each pocket in the circumferential direction have contact parts coming into contact with the balls at multiple points with intervals in a retainer axial direction.

2. The rolling bearing as claimed in claim 1, wherein, on both ends of each pocket in the circumferential direction, a plurality of tapered surfaces inclined with respect to a plane including a shaft center of the retainer and passing through a center of the pocket is formed, and each contact part is provided on each tapered surface.

3. The rolling bearing as claimed in claim 2, wherein the plurality of tapered surfaces formed on one end of each pocket in the circumferential direction may is provided on one of the annular bodies.

4. The rolling bearing as claimed in claim 1, wherein the ball is a ceramic ball.

5. The rolling bearing as claimed in claim 1, wherein the rolling bearing is a rolling bearing for a motor.

6. A rolling bearing comprising:
an inner ring;
an outer ring;
a plurality of balls interposed between the inner ring and the outer ring; and
a retainer having a pocket for retaining the balls; wherein
the retainer has two annular bodies configured to be superposed on each other in an axial direction;
each of the annular bodies includes: a plurality of pocket wall parts arranged at predetermined intervals in a circumferential direction, each of which constitutes an inner wall surface of a pocket; and a plurality of connecting plate parts connecting the pocket wall parts adjacent in the circumferential direction;
the two annular bodies are superposed on and coupled to each other at the respective connecting plate parts and lubricated by grease; and
a grease reservoir wall is provided on an inner circumferential surface of the connecting plate part to deposit grease and prevent grease from flowing axially outward from the inner circumferential surface.

7. The rolling bearing as claimed in claim 6, wherein the grease reservoir walls are provided on both edges in the axial direction of the inner circumferential surface of the connecting plate parts.

8. The rolling bearing as claimed in claim 6, wherein a minimum diameter of the grease reservoir wall is larger than an outer diameter of the inner ring and smaller than an inner diameter of the retainer.

9. The rolling bearing as claimed in claim 6, wherein the ball is a ceramic ball.

10. The rolling bearing as claimed in claim 6, wherein the rolling bearing is a rolling bearing for a motor.
